(19) United States
(12) Patent Application Publication
(10) Pub. No.: US 2026/0104331 A1
(43) Pub. Date: Apr. 16, 2026

(54) Methods, Devices, and Apparatus for Washing Samples with Integrated Dispenser-Washer Nozzles

(71) Applicant: Curiox Biosystems Co., Ltd, Seoul (KR)

(72) Inventors: Kong Leong CHENG, Singapore (SG); Namyong KIM, Vancouver (CA)

(21) Appl. No.: 19/418,910

(22) Filed: Dec. 12, 2025

Related U.S. Application Data
(63) Continuation of application No. PCT/IB2024/055772, filed on Jun. 13, 2024.
(60) Provisional application No. 63/507,939, filed on Jun. 13, 2023.

(51) Int. Cl. G01N 1/34

(52) U.S. Cl. CPC G01N 1/34

(57) ABSTRACT

An apparatus includes a dispenser with a dispenser nozzle for dispensing a wash liquid to a sample liquid and an aspirator with an aspirator nozzle, distinct from the dispenser nozzle, for aspirating a mixture of the wash liquid and the sample liquid. The dispenser nozzle is integrated with the aspirator nozzle. A method includes dispensing a wash liquid to a sample liquid with a dispenser nozzle integrated with an aspirator nozzle and aspirating a mixture of the wash liquid and the sample liquid with the aspirator nozzle.

### RELATED APPLICATIONS

This application is a continuation application of the International Patent Application No. PCT/IB2024/055772, filed on Jun. 13, 2024, which claims the benefit of, and priority to, U.S. Provisional Patent Application Ser. No. 63/507,939, filed on Jun. 13, 2023, both of which are incorporated by reference herein in their entireties.

### TECHNICAL FIELD

This application relates generally to methods, devices, and apparatus for washing samples (e.g., cells, particles, etc.), and more particularly to methods, devices, and apparatus for washing samples on plates.

### BACKGROUND

An array plate is also called a plate, microtiter plate, microplate, or microwell plate. Array plates are typically used to hold respective liquid droplets separately for biological and/or chemical reaction. For example, a well-type array plate includes a plurality of wells so that each liquid droplet or each sample may be dispensed into a separate well for further processing. Typically, the number of wells is selected from 6, 24, 96, 384, 1536, 3456, and 9600.

Samples (e.g., cells) are frequently washed in many biological processes and assays. Washing samples typically involves adding a wash solution to a sample solution, which includes samples (e.g., cells), and removing the mixture of the wash solution and the sample solution. By repeating the dilution and partial removal of the sample solution, the concentration of chemicals and/or biological reagents other than the samples are reduced. However, variations in the sample washing increase measurement errors, which are undesirable for accurate assays.

In addition, certain cells (e.g., suspension cells, non-adherent cells, and weakly adherent cells) do not strongly adhere to the plate. Thus, during removal of the mixture, cells may be removed along with the mixture, thereby reducing the number of cells that remain on the plate. Because the reliability of cell-based reactions typically requires a sufficient number of cells, the loss of cells during washing negatively affects cell-based reactions.

### SUMMARY

Accordingly, there is need for methods, devices, and apparatus that provide improved accuracy and reduced time in washing cells. Such methods, devices, and apparatus plates may replace the conventional methods, devices, and apparatus for washing cells. In addition, such methods, devices, and apparatus may better retain cells during washing, and reduce or eliminate the loss of cells during washing, thereby improving the reliability of cell-based reactions. Similarly, such methods, devices, and apparatus may be used in washing other types of samples, such as beads or particles conjugated with target molecules.

A number of embodiments that overcome the limitations and disadvantages of existing methods, devices, and apparatus are presented in more detail below. These embodiments provide methods, devices, and apparatus for washing a sample in a solution.

As described in more detail below, in accordance with some embodiments, an apparatus for washing a sample in a sample liquid includes a dispenser with a dispenser nozzle for dispensing a wash liquid to a sample liquid and an aspirator with an aspirator nozzle, distinct from the dispenser nozzle, for aspirating a mixture of the wash liquid and the sample liquid. The dispenser nozzle is integrated with the aspirator nozzle.

In accordance with some embodiments, an apparatus includes a dispenser for dispensing a wash liquid to a sample liquid; an aspirator for aspirating a mixture of the wash liquid and the sample liquid; and a common nozzle fluidically coupled with both the dispenser and the aspirator so that the wash liquid dispensed by the dispenser is dispensed through the common nozzle and the mixture aspirated by the aspirator is aspirated through the common nozzle.

In accordance with some embodiments, a method includes dispensing a wash liquid to a sample liquid with a dispenser nozzle integrated with an aspirator nozzle and aspirating a mixture of the wash liquid and the sample liquid with the aspirator nozzle.

In accordance with some embodiments, a device includes a first nozzle and a second nozzle. The first nozzle is integrated with the second nozzle.

The apparatus, devices, and methods described herein address may replace conventional apparatus, devices, and methods. Alternatively, the apparatus, devices, and methods described herein address may complement conventional apparatus, devices, and methods.

### BRIEF DESCRIPTION OF THE DRAWINGS

For a better understanding of the aforementioned embodiments as well as additional embodiments, reference should be made to the Description of Embodiments below, in conjunction with the following drawings in which like reference numerals refer to corresponding parts throughout the figures.

FIG. 1 is a schematic diagram illustrating components of a sample washing apparatus (e.g., a washer) in accordance with some embodiments.

FIGS. 2A-2C are schematic diagrams illustrating example sources of variation in the residual volume.

FIGS. 3A-3D are schematic diagrams illustrating integrated nozzles and operations using the integrated nozzles in accordance with some embodiments.

FIGS. 4A-4G are top views of integrated nozzles in accordance with some embodiments.

FIG. 5 illustrates integrated nozzles with an extended tip in accordance with some embodiments.

FIGS. 6A and 6B illustrate integrated nozzles with a long extended tip in accordance with some embodiments.

FIGS. 7A-7C illustrate an integrated shared nozzle in accordance with some embodiments.

FIG. 8 illustrates mixing of a dispensed liquid during simultaneous dispensing and aspiration in accordance with some embodiments.

FIGS. 9A-9C illustrate integrated nozzles with a spiral flow in accordance with some embodiments.

FIGS. 10A-10C illustrate integrated nozzles with a radial flow in accordance with some embodiments.

Like reference numerals refer to corresponding parts throughout the drawings.

Drawings are not necessarily drawn to scale unless indicated otherwise.

### DESCRIPTION OF EMBODIMENTS

Methods, devices, and apparatus for washing samples are described. Reference will be made to certain embodiments, examples of which are illustrated in the accompanying drawings. While the claims will be described in conjunction with the embodiments, it will be understood that it is not intended to limit the claims to these particular embodiments alone. On the contrary, the embodiments are intended to cover alternatives, modifications and equivalents that are within the spirit and scope of the appended claims.

Moreover, in the following description, numerous specific details are set forth to provide a thorough understanding of the embodiments. However, it will be apparent to one of ordinary skill in the art that the embodiments may be practiced without these particular details. In other instances, methods, procedures, components, and networks that are well-known to those of ordinary skill in the art are not described in detail to avoid obscuring aspects of the embodiments.

It will also be understood that, although the terms first, second, etc. may be used herein to describe various elements, these elements should not be limited by these terms. These terms are only used to distinguish one element from another. For example, a first valve could be termed a second valve, and, similarly, a second valve could be termed a first valve, without departing from the scope of the embodiments. The first valve and the second valve are both valves, but they are not the same valve.

The terminology used in the description of the embodiments herein is for the purpose of describing particular embodiments only and is not intended to be limiting of the invention. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

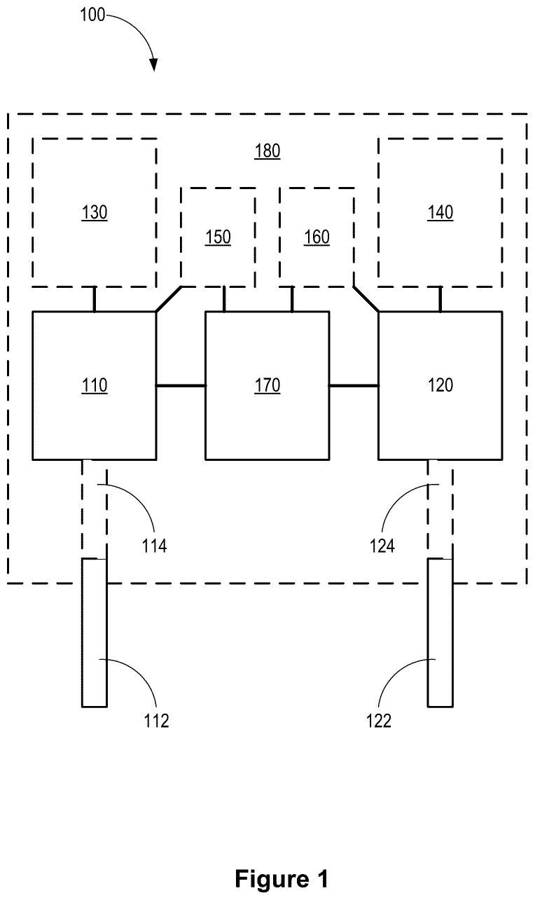

FIG. 1 is a schematic diagram illustrating components of a sample washing apparatus 100 (also called herein a washer) in accordance with some embodiments.

The washer 100 includes dispenser 110 (e.g., a liquid dispenser) and aspirator 120 (e.g., a liquid aspirator).

In some embodiments, dispenser 110 includes one or more movable components for dispensing liquid. For example, in some embodiments, dispenser 110 includes a pump (e.g., a centrifugal pump, a positive displacement pump, etc.) or a syringe. In some embodiments, dispenser 110 also includes an actuator (e.g., a linear actuator or a rotary actuator, such as a motor) for moving one or more movable components of the dispenser 110 (e.g., one or more components of the pump, such as an axle of a pump, or one or more components of the syringe, such as a piston). In some embodiments, the dispenser 110 includes a microactuator (e.g., a piezoelectric device) for dispensing liquid.

In some embodiments, aspirator 120 includes one or more movable components for aspirating liquid. For example, in some embodiments, aspirator 120 includes a pump (e.g., a centrifugal pump, a positive displacement pump, etc.) or a syringe. In some embodiments, aspirator 120 also includes an actuator (e.g., a linear actuator or a rotary actuator, such as a motor) for moving one or more movable components of the aspirator 120 (e.g., one or more components of the pump, such as an axle of a pump, or one or more components of the syringe, such as a piston). In some embodiments, the aspirator 120 includes a microactuator (e.g., a piezoelectric device) for aspirating liquid.

In some embodiments, the washer 100 includes dispenser reservoir 130 for storing a wash liquid (e.g., a wash buffer, such as phosphate buffered saline solution, tris buffered saline solution, etc.). The dispenser reservoir 130 is fluidically coupled to the dispenser 110 for providing a wash liquid stored therein to the dispenser 110. In some embodiments, the dispenser reservoir 130 is not part of the washer 100. In some embodiments, the washer 100 is fluidically coupled to an external dispenser reservoir (that is not part of the washer 100).

In some embodiments, the washer 100 includes aspirator reservoir 140. The aspirator reservoir 140 is fluidically coupled to the aspirator 120 for receiving an aspirated solution (e.g., a mixture of a wash liquid and a sample solution) from the aspirator 120 and storing the aspirated solution. In some embodiments, the aspirator reservoir 140 is not part of the washer 100. In some embodiments, the washer 100 is fluidically coupled to an external aspirator reservoir (that is not part of the washer 100).

In some embodiments, the washer 100 includes dispenser placement actuator 150. The dispenser placement actuator 150 is mechanically coupled to the dispenser 110 for moving the dispenser 110 (e.g., changing a position and/or an orientation of the dispenser 110, such as moving the dispenser vertically, horizontally, and/or diagonally). In some embodiments, the dispenser placement actuator 150 is not part of the washer 100. In some embodiments, the washer 100 or at least the dispenser 110 of the washer 100 is mechanically coupled to an external dispenser placement actuator (that is not part of the washer 100).

In some embodiments, the washer 100 includes aspirator placement actuator 160. The aspirator placement actuator 160 is mechanically coupled to the aspirator 120 for moving the aspirator 120 (e.g., changing a position and/or an orientation of the aspirator 120, such as moving the aspirator vertically, horizontally, and/or diagonally). In some embodiments, the aspirator placement actuator 160 is not part of the washer 100. In some embodiments, the washer 100 or at least the aspirator 120 of the washer 100 is mechanically coupled to an external aspirator placement actuator (that is not part of the washer 100).

In some embodiments, the washer 100 includes electronic controller 170 (e.g., one or more microcontrollers or processors, such as any combination of a central processing unit, a graphical processing unit, an accelerated processing unit, which may include integrated memory and/or may be electrically coupled to (non-integrated) memory). In some embodiments, the electronic controller 170 is electrically coupled to one or more of: the dispenser 110, the aspirator 120, the dispenser placement actuator 150, or the aspirator placement actuator 160 for controlling such electrically coupled devices or components. For example, in some embodiments, the electronic controller 170 is electrically coupled to the dispenser 110 for activating the dispenser 110 (e.g., by sending an electrical signal causing activation of the dispenser 110) so that the dispenser 110 dispenses liquid (e.g., wash liquid). In some embodiments, the electronic controller 170 is electrically coupled to the aspirator 120 for activating the aspirator 120 (e.g., by sending an electrical signal causing activation of the aspirator 120) so that the aspirator 120 aspirates liquid (e.g., a mixture of wash liquid and sample solution). In some embodiments, the electronic controller 170 is electrically coupled to the dispenser placement actuator 150 for activating the dispenser placement actuator 150 (e.g., by sending an electrical signal causing activation of the dispenser placement actuator 150) so that the dispenser placement actuator 150 moves the dispenser 110 (or changes a position and/or an orientation of the dispenser 110). In some embodiments, the electronic controller 170 is electrically coupled to the aspirator placement actuator 160 for activating the aspirator placement actuator 160 (e.g., by sending an electrical signal causing activation of the aspirator placement actuator 160) so that the aspirator placement actuator 160 moves the aspirator 120 (or changes a position and/or an orientation of the aspirator 120).

In some embodiments, the dispenser placement actuator 150 and the aspirator placement actuator 160 are integrated (e.g., a single actuator is configured to move both the dispenser 110 and the aspirator 120). For example, the integrated actuator may be mechanically coupled with both the dispenser 110 and the aspirator 120 to move both the dispenser 110 and the aspirator 120. In some embodiments, the integrated actuator is configured to move the dispenser 110 independently from the aspirator 120. In some embodiments, the integrated actuator is configured to move the dispenser 110 and the aspirator 120 concurrently (e.g., during an overlapping duration, and in some cases, in the same direction and by the same distance). In some embodiments, the integrated actuator is configured to move at least a nozzle of the dispenser 110 (e.g., dispenser nozzle 112) and a nozzle of the aspirator 120 (e.g., aspirator nozzle 122) concurrently. For example, in some embodiments, the integrated actuator is coupled with an integrated nozzle described below so that the integrated actuator moves the integrated nozzle.

The dispenser 110 is coupled to dispenser nozzle 112. In some embodiments, the dispenser 110 is fluidically coupled to the dispenser nozzle 112 so that liquid dispensed by the dispenser 110 is provided to the dispenser nozzle 112 and output from the dispenser nozzle 112. In some embodiments, the dispenser nozzle 112 is directly (e.g., mechanically) coupled to the dispenser 110 (e.g., without any other intervening component). In some embodiments, the dispenser nozzle 112 is indirectly coupled to the dispenser 110 (e.g., through one or more coupling components 114, such as a tubing).

The aspirator 120 is coupled to aspirator nozzle 122. In some embodiments, the aspirator 120 is fluidically coupled to the aspirator nozzle 122 so that liquid is aspirated through the aspirator nozzle 122 and then to the aspirator 120. In some embodiments, the aspirator nozzle 122 is directly (e.g., mechanically) coupled to the aspirator 120 (e.g., without any other intervening component). In some embodiments, the aspirator nozzle 122 is indirectly coupled to the aspirator 120 (e.g., through one or more coupling components 124, such as a tubing).

Although FIG. 1 illustrates only one dispenser 110 and only one aspirator 120 in the washer 100 so as not to obscure other aspects of the washer 100, in some embodiments, the washer 100 includes two or more dispensers. In some embodiments, the washer 100 includes two or more aspirators. In addition, in some embodiments, the washer 100 includes two or more dispenser reservoirs.

In some embodiments, the washer 100 includes one dispenser reservoir for each dispenser. In some embodiments, the washer 100 includes one dispenser reservoir for two or more dispensers. In some embodiments, the washer 100 includes two or more dispenser reservoirs, each of which is fluidically coupled to a respective subset of dispensers. In some embodiments, the washer 100 includes two or more aspirator reservoirs. In some embodiments, the washer 100 includes one aspirator reservoir for each aspirator. In some embodiments, the washer 100 includes one aspirator reservoir for two or more aspirators. In some embodiments, the washer 100 includes two or more aspirator reservoirs, each of which is fluidically coupled to a respective subset of aspirators.

In some embodiments, the washer 100 includes one dispenser placement actuator for each dispenser. In some embodiments, the washer 100 includes one dispenser placement actuator for two or more dispensers. In some embodiments, the washer 100 includes two or more dispenser placement actuators, each of which is coupled to a respective subset of dispensers. In some embodiments, the washer 100 includes two or more aspirator placement actuators. In some embodiments, the washer 100 includes one aspirator placement actuator for each aspirator. In some embodiments, the washer 100 includes one aspirator placement actuator for two or more aspirators. In some embodiments, the washer 100 includes two or more aspirator placement actuators, each of which is coupled to a respective subset of aspirators.

In some embodiments, one or more components illustrated in FIG. 1 (e.g., the dispenser 110, the aspirator 120, the electronic controller 170, etc.) are mechanically coupled to housing 180 (directly or indirectly). In some embodiments, the housing 180 substantially encloses one or more components illustrated in FIG. 1.

As explained above, variations in the sample washing increase measurement errors, which are undesirable for accurate assays. Some of the variations are caused by a liquid bridge formed between a nozzle tip and a top surface of a liquid.

### Residual Volume in Well

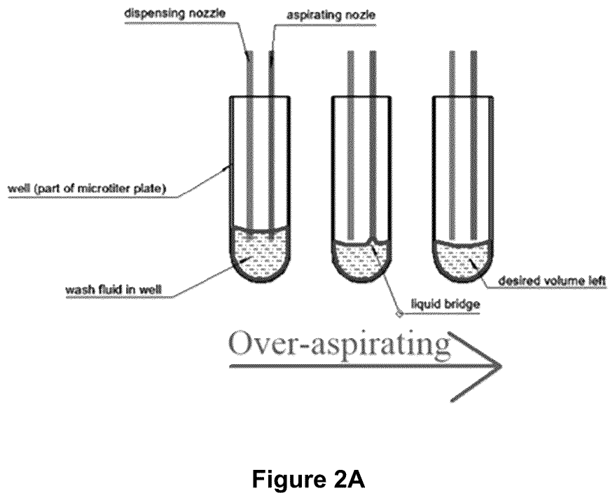

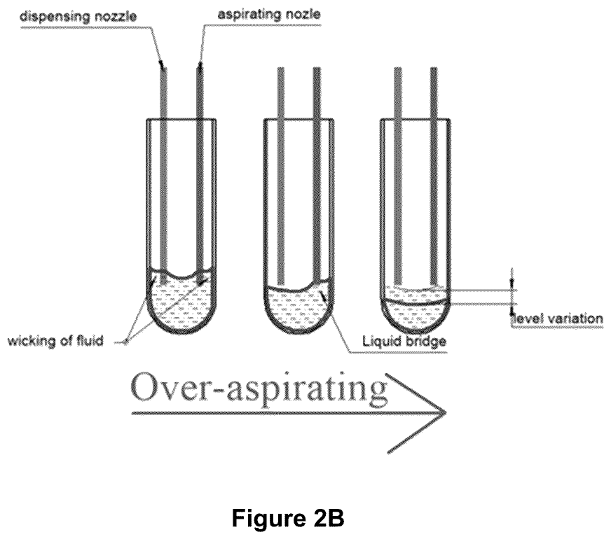

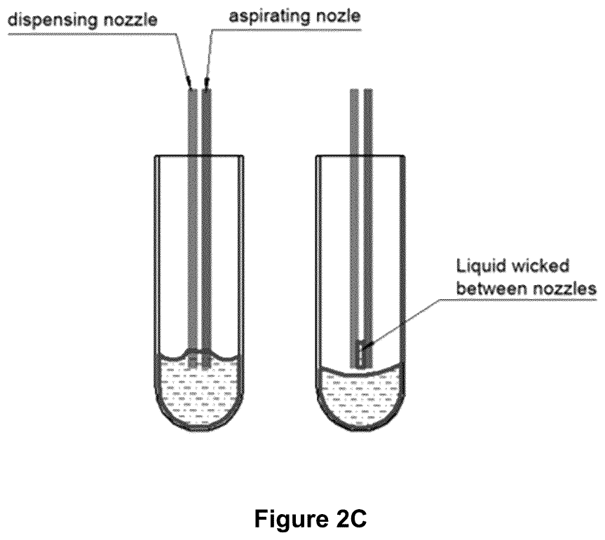

As illustrated in FIG. 2A, in order to leave a desired fluid volume after a wash, an aspiration nozzle may stay in a fixed position while aspirating, such that once the fluid level falls below the level of the nozzle tip and breaks contact with the nozzle tip, the aspiration of the fluid can cease.

In certain configurations, the breaking point may be very predictable. As the liquid level begins to fall below the level of the nozzle tip, the liquid may form a small bulge that is still in connection with the aspirating nozzle. This creates a small liquid bridge allowing more fluid to continue to be aspirated even when the nozzle tip is above the liquid level.

However, as more liquid is aspirated, the liquid bridge becomes thinner or smaller as the liquid level continues to recede, and ultimately the liquid bridge breaks. At this point, no more aspiration of the liquid occurs, even if the aspiration nozzle continues with its aspirating action (e.g., sucking in air). The volume of the fluid left in the well should match the desired volume.

### Wall Effect on Residual Volume

However, when the well diameter is relatively small, or if the two nozzles are relatively far apart, the nozzle positions will affect the wash dynamics. When nozzles are positioned closely to the well wall, the fluid will form meniscus between the nozzle and the well wall (partly due to the affinity between the fluid and the wall material).

As shown in FIG. 2B, the residual volume in a well can become unpredictable if an aspiration nozzle is too close to a well wall. The small distance between the well wall and the nozzle will cause fluid to be wicked between them. This wicking effect will reinforce the liquid bridge that is typically formed between the aspirating nozzle and the liquid surface such that the liquid bridge will not break until the liquid level is substantially lower. The problem with such an effect is that the breakage of the liquid level is much more varied in relation to the liquid level such that it can be much more difficult to predict when the breakage, and thereby, the cessation of aspiration, will occur. The result is that the volume of liquid left in the well will then be unpredictable and can vary substantially even if the same condition is repeated.

Furthermore, when a dispensing nozzle goes close to the wall, it also causes wicking, leading to variable left-over volume. Simply when either nozzle goes close to the wall, it causes a capillary action, leading to a poor control and poor predictability of a leftover volume.

### Wicking Effect of Nearby Nozzle

One way to counter the undesirable wicking effect between the well and the nozzles is to move the nozzles towards the center of the well. While this substantially reduces the liquid level variation caused by the interaction between the wall well and the nozzles and improves predictability of the volume of the residual liquid in the well, the closeness of the two nozzles may cause wicking and liquid trapping between the nozzles, as shown in FIG. 2C. Such liquid trapping is especially undesirable because it can be brought over and contaminate a next well that is to be washed by the same set of nozzles.

Even if the liquid trapped between nozzles is not transported to another well, such wicking/capillary action leads to poor control and poor predictability of a leftover volume.

### Integrated Nozzles

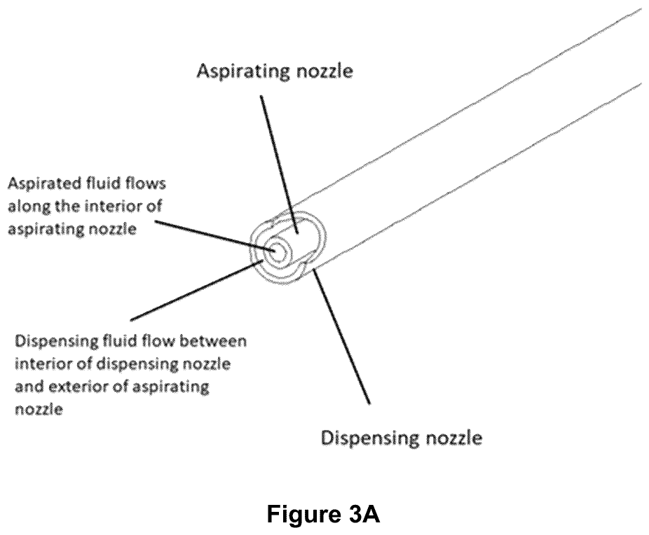

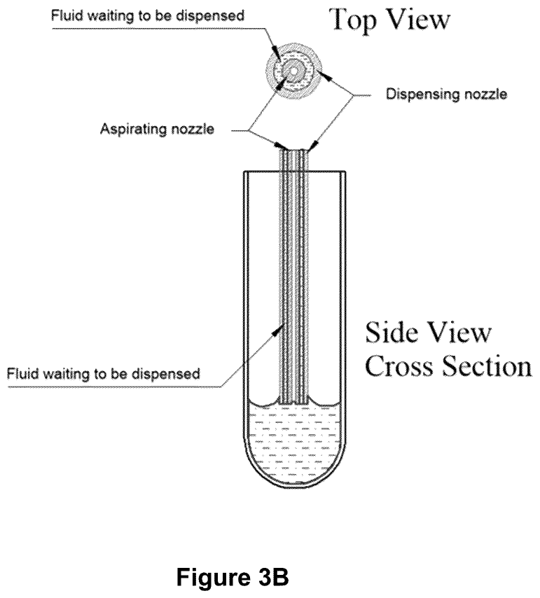

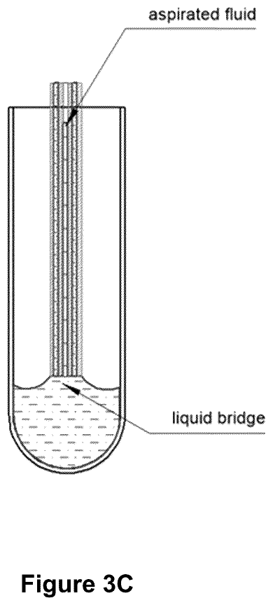

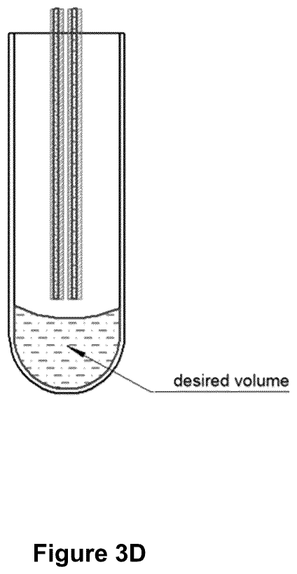

To eliminate the problem faced with using individual nozzles for dispensing and aspirating, one way is to integrate the dispensing nozzle and the aspirating nozzle. For example, in some embodiments, the dispensing and aspirating nozzles are placed about a same axis, as shown in FIG. 3A. In some embodiments, a smaller diameter aspirating nozzle is placed inside a larger diameter dispensing nozzle, as shown in FIG. 3A. In some other embodiments, a smaller diameter dispensing nozzle is placed inside a larger diameter aspirating nozzle.

For the nozzles shown in FIG. 3A, to dispense fluid into a well, the dispensing fluid will flow along the space between the dispensing nozzle and aspirating nozzle from the upper reach of the nozzle towards the opening at the lower end of the nozzle, which would be beneath the surface of the liquid.

To aspirate fluid from the well, the aspirating nozzle creates a negative pressure in the interior of the aspirating nozzle. The pressure differential between atmosphere and the aspirating nozzle interior will force liquid to flow up along aspirating nozzle, thereby removing fluid from the well.

FIG. 3B illustrates a top view and a side sectional view of integrated coaxial dispensing and aspirating nozzles. With the nozzles in away from the well wall (e.g., toward the center of the well), the interaction between the well wall and the nozzles is reduced (e.g., the meniscus formed between on the nozzles and the well wall is reduced). The reduction of such interference enhances the predictability of the volume of the residual liquid after aspiration.

FIG. 3C illustrates a liquid bride formed between the integrated nozzles and the liquid surface during aspiration.

FIG. 3D illustrates the break between the integrated nozzles and the liquid surface, which causes cessation of further aspiration of the liquid.

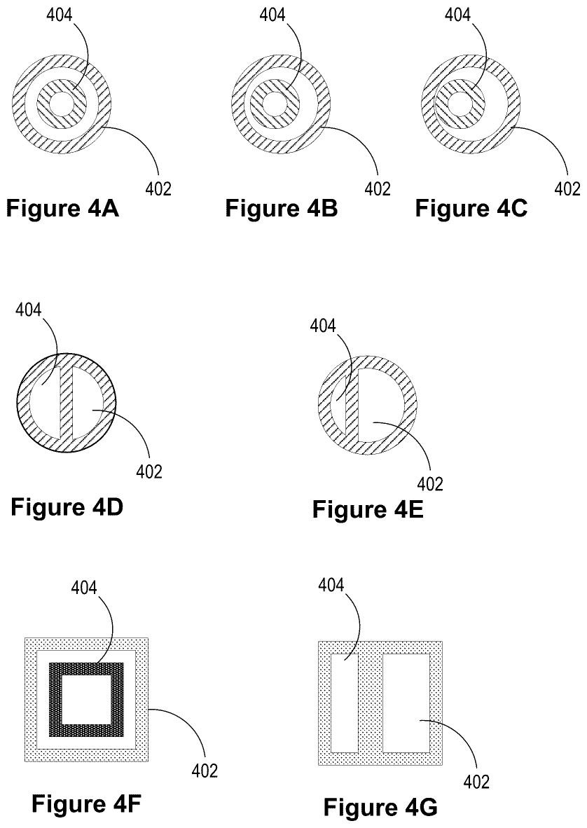

FIGS. 4A-4G illustrate top views of integrated dispenser-aspirator nozzles in accordance with some embodiments.

FIG. 4A illustrates a top view of integrated dispenser-aspirator nozzles in accordance with some embodiments, where the integrated dispenser-aspirator nozzles include two coaxial nozzles 402 and 404. As described with respect to FIGS. 3A and 3B, in some embodiments, the larger diameter nozzle 402 operates as a dispenser nozzle and the smaller diameter nozzle 404 operates as an aspirator nozzle. In some other embodiments, the larger diameter nozzle 402 operates as an aspirator nozzle and the smaller diameter nozzle 404 operates as a dispenser nozzle.

FIGS. 4B and 4C illustrate top views of integrated dispenser-aspirator nozzles in accordance with some embodiments, where the integrated dispenser-aspirator nozzles include two nozzles 402 and 404 that are not coaxially positioned. In FIG. 4B, the nozzle 402 and the nozzle 404 are separate from each other (e.g., the nozzle 402 is not in contact with the nozzle 404). In FIG. 4C, the nozzle 402 and the nozzle 404 are in contact with each other. Similar to integrated nozzles shown in FIG. 4A, in some embodiments, the nozzle 402 operates as a dispenser nozzle and the nozzle 404 operates as an aspirator nozzle. In some other embodiments, the nozzle 402 operates as an aspirator nozzle and the nozzle 404 operates as a dispenser nozzle.

FIGS. 4D and 4E illustrate top views of integrated dispenser-aspirator nozzles in accordance with some embodiments, where the integrated dispenser-aspirator nozzles include two disk-segment shaped nozzles 402 and 404. In FIG. 4D, the nozzle 402 and the nozzle 404 have the same size (e.g., the nozzle 402 and the nozzle 404 have the shape of a half circle). In FIG. 4E, the nozzle 402 and the nozzle 404 have different sizes (e.g., the nozzle 402 is larger than the nozzle 404). Similar to integrated nozzles shown in FIG. 4A, in some embodiments, the nozzle 402 operates as a dispenser nozzle and the nozzle 404 operates as an aspirator nozzle. In some other embodiments, the nozzle 402 operates as an aspirator nozzle and the nozzle 404 operates as a dispenser nozzle.

FIGS. 4F and 4G illustrate top views of integrated dispenser-aspirator nozzles in accordance with some embodiments, where the integrated dispenser-aspirator nozzles include two rectangular nozzles 402 and 404. In FIG. 4F, the nozzle 402 is a larger rectangular nozzle and the nozzle 404 is a smaller rectangular nozzle located inside the nozzle 402. As described with respect to FIGS. 3A and 3B, in some embodiments, the larger nozzle 402 operates as a dispenser nozzle and the smaller nozzle 404 operates as an aspirator nozzle. In some other embodiments, the larger nozzle 402 operates as an aspirator nozzle and the smaller nozzle 404 operates as a dispenser nozzle. In some embodiments, the nozzles 402 and 404 are positioned coaxially, as shown in FIG. 4F. In some embodiments, the nozzles 402 and 404 are not positioned coaxially (e.g., the nozzle 402 may be in contact with the nozzle 404, or the nozzle 404 may be positioned off center of the nozzle 402). In FIG. 4G, the nozzle 402 and the nozzle 404 are positioned next to each other, but the nozzle 402 is not located inside the nozzle 404 and the nozzle 404 is not located inside the nozzle 402. In some embodiments, the nozzle 402 has a square shape. In some embodiments, the nozzle 402 has a non-square rectangular shape. In some embodiment, the nozzle 402 has a rectangular shape with one or more rounded corners. In some embodiments, the nozzle 404 has a square shape. In some embodiments, the nozzle 404 has a non-square rectangular shape. In some embodiment, the nozzle 404 has a rectangular shape with one or more rounded corners. In some embodiments, the nozzle 402 has a non-rectangular shape (e.g., a triangle, a pentagon, a hexagon, a heptagon, an octagon, a nonagon, a decagon, a trapezoid, an ellipse, an oval, etc.). In some embodiments, the nozzle 404 has a non-rectangular shape (e.g., a triangle, a pentagon, a hexagon, a heptagon, an octagon, a nonagon, a decagon, a trapezoid, an ellipse, an oval, etc.).

### Integrated Nozzles With Tip Extension

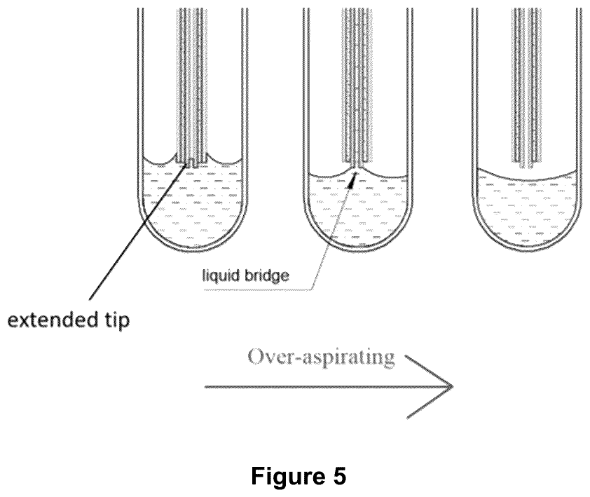

FIG. 5 illustrates integrated nozzles with an extended tip in accordance with some embodiments.

When the coaxial nozzles having the same length are used, both nozzles are in contact with the liquid bridge just before breakage from the liquid surface. If the larger diameter nozzle is used as a dispensing nozzle, the edge of dispensing nozzle is closer to the well wall. If a well has a small diameter (e.g., close to the diameter of the large diameter dispensing nozzle), the wall meniscus may still have an undesirable effect on the liquid bridge bulge, thereby causing variations in the volume of the residual liquid.

In order to mitigate such an effect, integrated nozzles with the inner nozzle tip extending below the tip of the outer nozzle, as shown in FIG. 5, are used in some embodiments. In some embodiments, the inner nozzle is longer than the outer nozzle. In some embodiments, the inner nozzle is positioned in a way such that the tip of the inner nozzle is located below the tip of the outer nozzle (where the length of the inner nozzle may or may not match the length of the outer nozzle).

During the normal wash operation where dispensing and aspirating is occurring, both nozzle tips may be submerged beneath the liquid surface. However, when aspiration to leave a desired volume in the well is required, aspiration will proceed while the liquid level falls below that of both nozzles, with only the liquid bridge bulge remaining in contact with the inner aspirating nozzle, because the tip of the inner aspirating nozzle is located closer to the liquid surface than the tip of the outer dispensing nozzle is to the liquid surface.

The inner nozzle, with a smaller diameter, has its edge further away from the wall than the outer nozzle is from the wall. This allows the liquid bridge bulge to be smaller and further away from the wall meniscus, so that interference from the wall meniscus is reduced even if the outer nozzle is in contact with the liquid bridge bulge.

In some embodiments, integrated nozzles with the tip of the inner nozzle located above the tip of the outer nozzle may be used. Such design provides better removal of the fresh wash buffer present around the dispensing nozzle. In some embodiments, the inner nozzle is shorter than the outer nozzle. In some embodiments, the inner nozzle is positioned in a way such that the tip of the inner nozzle is located above the tip of the outer nozzle (where the length of the inner nozzle may or may not match the length of the outer nozzle).

### Integrated Nozzles With Long Extended Tip

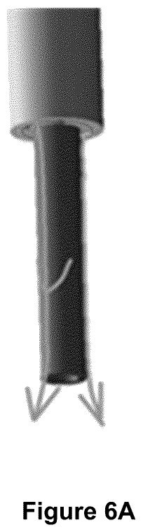

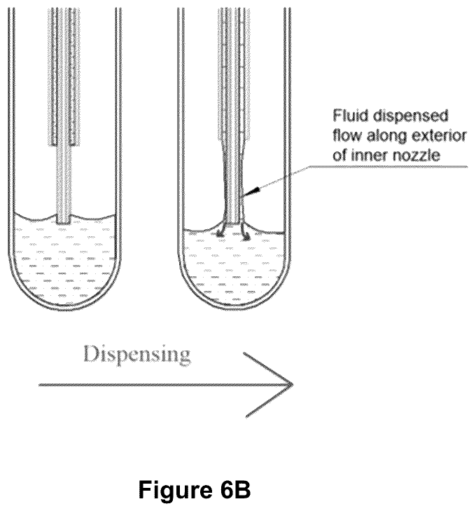

FIGS. 6A and 6B illustrate integrated nozzles with a long extended tip in accordance with some embodiments.

If the interference of the wall meniscus with the outer nozzle is still significant, the inner nozzle tip can be extended further as shown in FIG. 6A. This allows the outer nozzle to remain above the liquid level during the dispensing operation. In such a scenario, the dispensing (outer) nozzle will dispense fluid when it is above liquid level while the aspiration (inner) nozzle tip is submerged beneath the liquid level, as shown in FIG. 6B. The dispensed fluid, due to its surface affinity, will flow along the outer surface of the inner nozzle to reach the bulk fluid in the well.

### Shared Nozzle

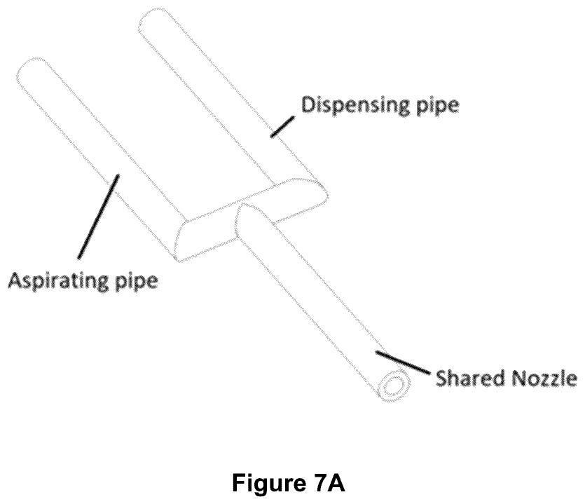

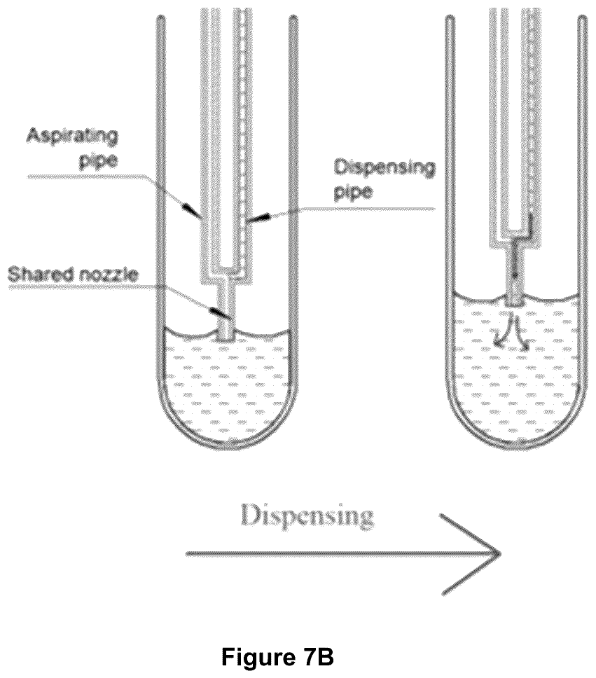

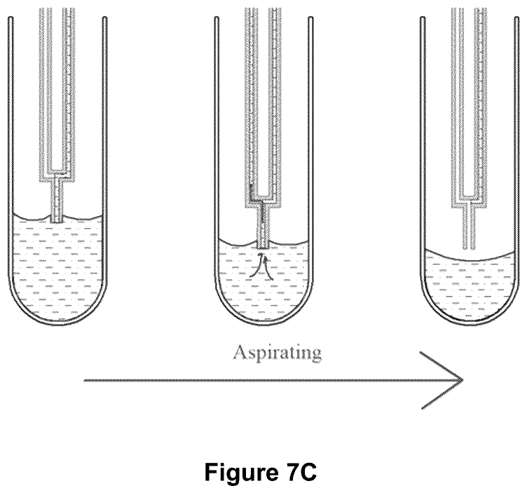

FIGS. 7A and 7B illustrate an integrated nozzle in accordance with some embodiments.

The integrated nozzle shown in FIG. 7A includes a shared nozzle so that only a single nozzle contacts the liquid surface during washing. The shared nozzle is connected to both the dispenser (via a dispenser pipe) and the aspirator (via an aspirating pipe). In some embodiments, only one of dispensing or aspirating is performed exclusively at each time with the integrated nozzle so that the shared nozzle performs either dispensing or aspiration, but not both.

To dispense liquid from the shared nozzle, the liquid is pushed towards the T-joint connecting the dispensing pipe, aspirating pipe and the shared nozzle. In order to dispense liquid through the shared nozzle, the aspirating pipe is configured to prevent flow of a liquid (e.g., by closing a device, such as a valve downstream of the aspirating pipe, or by applying a positive pressure so that the liquid will not flow into the aspirating pipe), and the liquid flows down through the shared nozzle, and into the well, as shown in FIG. 7B. In some embodiments, the position of the integrated nozzle is adjusted during the dispensing operation (e.g., the integrated nozzle is moved up in tandem with the rising liquid level) in order to reduce or maintain the area of contact between the integrated nozzle and the liquid in the well.

To aspirate liquid from the shared pipe, a low pressure (e.g., a negative pressure) is provided in the aspirating pipe while the dispensing pipe fluid flow is configured to prevent flow of a liquid (e.g., by closing a device, such as a valve upstream of the dispensing pipe, or by applying a positive pressure so that the liquid will not flow into the dispensing pipe). The low pressure is transmitted through the aspirating pipe to the shared nozzle, which will then aspirate a portion of the bulk liquid in the well, as shown in FIG. 7C. In some embodiments, the position of the integrated nozzle is adjusted during the aspiration operation (e.g., the integrated nozzle is moved down in tandem with the falling liquid level) in order to maintain the contact between the integrated nozzle and the liquid, until the integrated nozzle reaches a pre-determined level where it stops moving while continuing to aspirate until the contact between the liquid and the integrated nozzle breaks.

Although FIGS. 7A-7C illustrate an integrated nozzle having a shape of a field goal post, an integrated nozzle having any other shape may be used. For example, an integrated nozzle having a shape of a tuning fork or a letter Y or a latter T may be used.

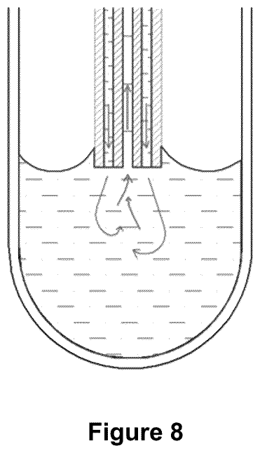

Because the integrated nozzles have the dispenser nozzle and the aspirator nozzle next to each other, if a washing operation includes simultaneous dispensing (of a wash liquid) and aspiration (of a mixture), the dispensed liquid may be aspirated before it is fully mixed with the rest of the sample solution in the well, thereby reducing the wash effectiveness, as shown in FIG. 8.

Certain modifications to the integrated nozzles direct the flow of the dispensed liquid away from the aspirating nozzle, thereby enhancing the washing efficiency.

### Spiral Outlet

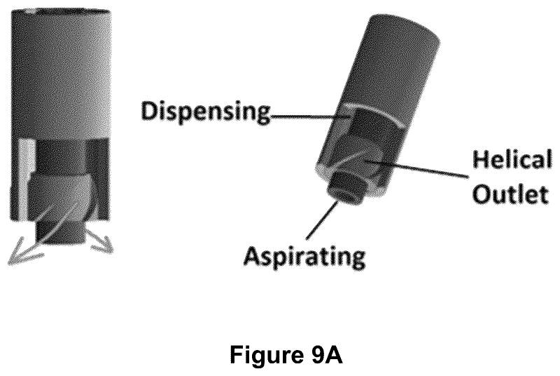

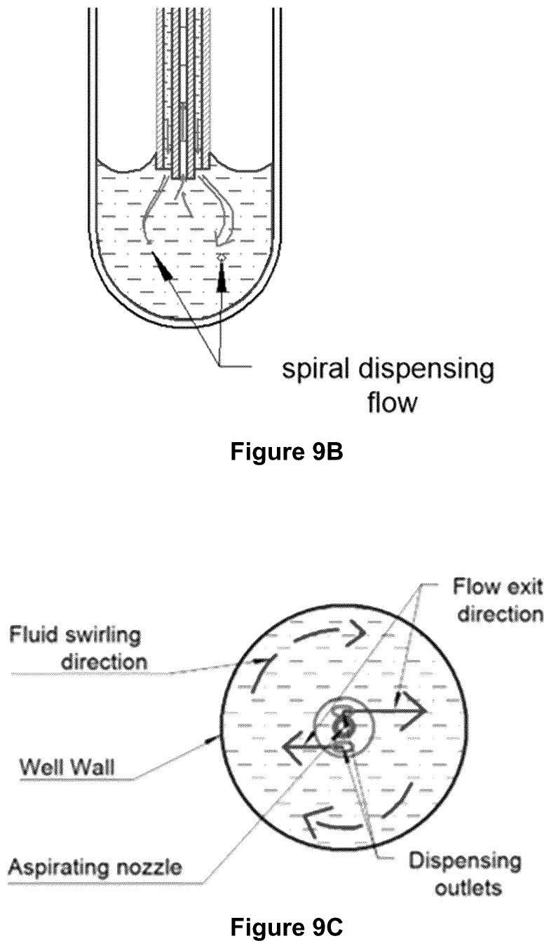

FIG. 9A illustrates partial cross-sectional views of integrated nozzles with a flow deflector in accordance with some embodiments. This configuration uses a flow deflecting structure at the exit of the nozzle, which causes the fluid to spiral around the center axis as the fluid moves downwards. Upon exiting the dispensing nozzle, the spiral action causes the dispensed fluid to move away from the center axis. This promotes mixing of the dispensed fluid into the rest of the fluid located further away from the nozzles. In some embodiments, the flow deflector is integrally formed with the inner nozzle. In some embodiments, the flow deflector is a separate component (e.g., a separately formed component) attached to the inner nozzle. In some embodiments, the flow deflector has a helical outlet (e.g., a pathway that has a helical pattern around the inner nozzle). In some embodiments, the flow deflector has an angled channel. FIG. 9B is a front sectional view illustrating that the spiral flow forces the dispensed flow away from the center axis.

The helical outlet will not only direct the dispensed fluid further away from the tip of the aspirating nozzle, but it will also impart a rotational force on the fluid. This will cause the fluid to swirl, as shown in FIG. 9C, which is a plan view illustrating the rotational force imparted by the dispensed fluid. This reduces the likelihood of forming dead zones, where little or no mixing occurs with the fresh wash buffer throughout the wash process.

### Radial Outlet

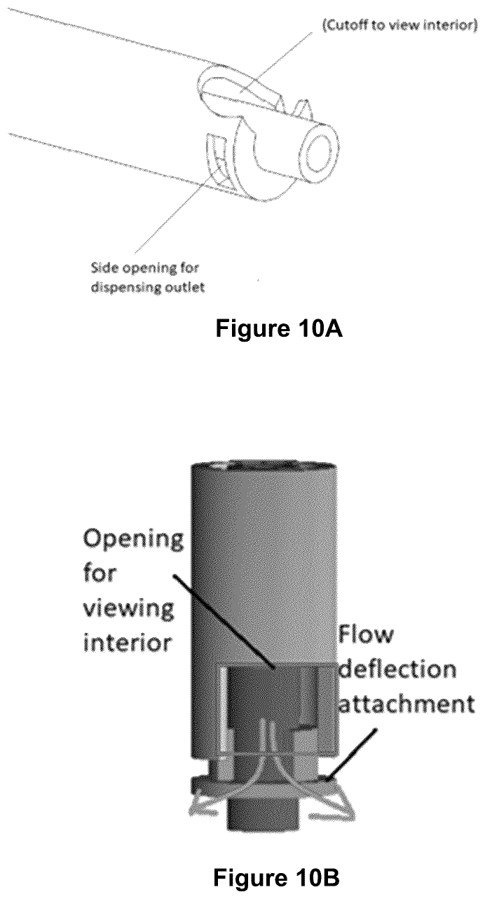

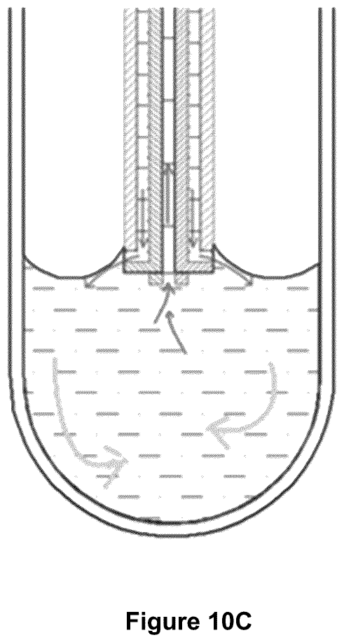

FIG. 10A illustrates a partial cross-sectional view of integrated nozzles with a radial outlet in accordance with some embodiments. This configuration prevents dispensing liquid along the axis (defined by the nozzles) into the well, but instead dispenses the liquid laterally. In FIG. 10A, one or more lateral openings are defined in the outer nozzle near the nozzle tip for dispensing the liquid.

FIG. 10B illustrates a partial cross-sectional view of integrated nozzles with a flow deflector. The flow deflector changes the direction of the dispensed liquid to a direction that is non-parallel to the axis defined by the integrated nozzles (or their shafts). For example, the flow deflector may change the direction of the dispensed liquid to one or more radial directions. In some embodiments, the flow deflector is integrally formed with the inner nozzle. In some embodiments, the flow deflector is integrally formed with the inner nozzle. In some embodiments, the flow deflector is a separate component (e.g., a separately formed component) attached to the inner nozzle.

With the exit at the side of the nozzle tip, the dispensed fluid is forced to flow radially from the central axis towards the well edge. The dispensed fluid will then be dispersed toward the outer edge of the bulk fluid, so that with aspiration occurring in the center of the well, a circulating flow will occur throughout the fluid as shown in FIG. 10C, thereby promote fluid mixing and hence enhances the effectiveness of the washing operation.

In some embodiments, the washing is performed by alternating the dispensing and aspiration in a serial manner. Furthermore, the nozzle and the well (or a well plate) may move around against each other while the aspiration occurs at a fixed position, preferably away from the wall. The physical movement of a nozzle against a plate (or the well) during dispensing improves the mixing efficiency by further distributing the wash buffer.

In view of these examples and principles, we now turn to certain embodiments.

In accordance with some embodiments, an apparatus includes a dispenser with a dispenser nozzle for dispensing a wash liquid to a sample liquid and an aspirator with an aspirator nozzle, distinct from the dispenser nozzle, for aspirating a mixture of the wash liquid and the sample liquid. The dispenser nozzle is integrated with the aspirator nozzle.

In some embodiments, the dispenser nozzle is in contact with the aspirator nozzle.

In some embodiments, the dispenser nozzle is at least partially surrounded by the aspirator nozzle.

In some embodiments, at least a portion of the dispenser nozzle is located inside the aspirator nozzle.

In some embodiments, the aspirator nozzle is at least partially surrounded by the dispenser nozzle.

In some embodiments, at least a portion of the aspirator nozzle is located inside the dispenser nozzle.

In some embodiments, the dispenser nozzle and the aspirator nozzle are coaxially positioned.

In some embodiments, the dispenser nozzle and the aspirator nozzle are not coaxially positioned.

In some embodiments, the dispenser nozzle and the aspirator nozzle have the same shape.

In some embodiments, the dispenser nozzle has a round shape.

In some embodiments, the dispenser nozzle has a nonround shape.

In some embodiments, the aspirator nozzle has a round shape.

In some embodiments, the aspirator nozzle has a nonround shape.

In some embodiments, a tip of the aspirator nozzle is located below a tip of the dispenser nozzle.

In some embodiments, a tip of the aspirator nozzle is located above a tip of the dispenser nozzle.

In some embodiments, a flow deflector coupled with the dispenser nozzle.

In some embodiments, the flow deflector causes a spiral flow of the dispensed wash liquid.

In some embodiments, the flow deflector causes a radial flow of the dispensed wash liquid.

In some embodiments, one or more cutouts are defined in the dispensing nozzle for dispensing the wash liquid in one or more directions nonparallel to an axis defined by a shaft of the dispensing nozzle.

In some embodiments, the direction of the dispensed wash liquid is perpendicular to an axis defined by a shaft of the dispensing nozzle.

In some embodiments, the apparatus includes an actuator coupled with the dispenser nozzle and the aspirator nozzle. The actuator is configured to move the dispenser nozzle and the aspirator nozzle while at least the dispenser dispenses the wash liquid or at least the aspirator aspirates the mixture.

In some embodiments, the actuator is configured to move the dispenser nozzle and the aspirator nozzle concurrently.

In some embodiments, the actuator is configured to move the dispenser nozzle and the aspirator nozzle between a first location where the dispenser nozzle and the aspirator nozzle are in contact with the mixture (e.g., the dispenser nozzle and the aspirator nozzle are immersed in the mixture) and a second location where the dispenser nozzle and the aspirator nozzle are not in contact with the mixture (e.g., from the first location to the second location). This allows the dispenser nozzle and the aspirator nozzle to break from a surface of the mixture.

In some embodiments, the apparatus is configured to, while the dispenser nozzle and the aspirator nozzle are not immersed in the mixture, cause the dispenser to dispense the wash liquid and subsequently cause the aspirator to aspirate. This allows the apparatus to perform a self-cleaning operation for the dispenser nozzle and the aspirator nozzle.

In some embodiments, the apparatus is configured to move the dispenser nozzle while dispensing the wash liquid so that a distance from a tip of the dispenser nozzle to a top surface of the mixture remains substantially the same. In some embodiments, the apparatus is configured to move the dispenser nozzle immersed in the sample liquid or the mixture while dispensing the wash liquid so that a distance from a tip of the dispenser nozzle to a top surface of the mixture remains substantially the same.

In some embodiments, the apparatus is configured to move the aspirator nozzle while aspirating the mixture so that a distance from a tip of the aspirator nozzle to a top surface of the mixture remains substantially the same. In some embodiments, the apparatus is configured to move the aspirator nozzle immersed in the mixture while aspirating the mixture so that a distance from a tip of the aspirator nozzle to a top surface of the mixture remains substantially the same. For example, the apparatus may lower the aspirator nozzle as the volume of the mixture decreases during aspiration and the top surface of the mixture moves down so that the distance between the tip of the aspirator nozzle and the top surface of the mixture remains the same.

In some embodiments, the apparatus is configured to maintain the position of the dispenser nozzle while dispensing the wash liquid. In some embodiments, the apparatus is configured to maintain the position of the dispenser nozzle above the sample liquid or the mixture while dispensing the wash liquid.

In some embodiments, the apparatus is configured to maintain the position of the aspirator nozzle while aspirating the mixture.

In accordance with some embodiments, an apparatus includes: a dispenser for dispensing a wash liquid to a sample liquid; an aspirator for aspirating a mixture of the wash liquid and the sample liquid; and a common nozzle fluidically coupled with both the dispenser and the aspirator so that the wash liquid dispensed by the dispenser is dispensed through the common nozzle and the mixture aspirated by the aspirator is aspirated through the common nozzle.

In some embodiments, the apparatus further includes an aspirator valve located between the common nozzle and the aspirator.

In some embodiments, the apparatus further includes a dispenser valve coupled with the dispenser.

In some embodiments, the apparatus further includes an electrical controller electrically coupled with the dispenser to cause the dispenser to dispense the wash liquid and electrically coupled with the aspirator to cause the aspirator to aspirate the mixture.

In some embodiments, the electrical controller is configured to cause the dispenser to dispense the wash liquid while the aspirator aspirates the mixture.

In some embodiments, the electrical controller is configured to cause the aspirator to aspirate the mixture while the dispenser dispenses the wash liquid.

In some embodiments, the electrical controller is configured to cause dispensing of the wash liquid by the dispenser and aspiration of the mixture by the aspirator to alternate.

In some embodiments, the apparatus further includes an actuator coupled with the common nozzle, wherein the actuator is configured to move the common nozzle while at least the dispenser dispenses the wash liquid or at least the aspirator aspirates the mixture.

In some embodiments, the actuator is configured to move the common nozzle between a first location where the common nozzle is in contact with the mixture and a second location where the common nozzle is not in contact with the mixture.

In accordance with some embodiments, a method includes dispensing a wash liquid to a sample liquid with a dispenser nozzle integrated with an aspirator nozzle and aspirating a mixture of the wash liquid and the sample liquid with the aspirator nozzle.

In some embodiments, the dispenser nozzle is in contact with the aspirator nozzle.

In some embodiments, the dispenser nozzle is at least partially surrounded by the aspirator nozzle.

In some embodiments, at least a portion of the dispenser nozzle is located inside the aspirator nozzle.

In some embodiments, the aspirator nozzle is at least partially surrounded by the dispenser nozzle.

In some embodiments, at least a portion of the aspirator nozzle is located inside the dispenser nozzle.

In some embodiments, the dispenser nozzle and the aspirator nozzle are coaxially positioned.

In some embodiments, the dispenser nozzle and the aspirator nozzle are not coaxially positioned.

In some embodiments, the dispenser nozzle and the aspirator nozzle have the same shape.

In some embodiments, the dispenser nozzle has a round shape.

In some embodiments, the dispenser nozzle has a nonround shape.

In some embodiments, the aspirator nozzle has a round shape.

In some embodiments, the aspirator nozzle has a nonround shape.

In some embodiments, a tip of the aspirator nozzle is located below a tip of the dispenser nozzle.

In some embodiments, the wash liquid is dispensed while the dispenser nozzle is located above a top surface of the sample liquid or a mixture of the wash liquid and the sample liquid; and the mixture of the wash liquid and the sample liquid is aspirated while the aspirator nozzle is located below the top surface of the mixture of the wash liquid and the sample liquid.

In some embodiments, a tip of the aspirator nozzle is located above a tip of the dispenser nozzle.

In some embodiments, the method further includes using an electrical controller electrically coupled with the dispenser to cause the dispenser to dispense the wash liquid and electrically coupled with the aspirator to cause the aspirator to aspirate the mixture.

In some embodiments, the method further includes using the electrical controller to cause the dispenser to dispense the wash liquid while the aspirator aspirates the mixture.

In some embodiments, the method further includes using the electrical controller to cause the aspirator to aspirate the mixture while the dispenser dispenses the wash liquid.

In some embodiments, the method further includes using the electrical controller to cause dispensing of the wash liquid by the dispenser and aspiration of the mixture by the aspirator to alternate.

In some embodiments, the method further includes dispensing the wash liquid while aspirating the mixture.

In some embodiments, the method further includes aspirating the mixture while dispensing the wash liquid.

In some embodiments, the method further includes alternating dispensing of the wash liquid and aspiration of the mixture.

In accordance with some embodiments, a device includes a first nozzle and a second nozzle, distinct from the first nozzle. The first nozzle is integrated with the second nozzle.

In some embodiments, the first nozzle is in contact with the second nozzle.

In some embodiments, the first nozzle is at least partially surrounded by the second nozzle.

In some embodiments, at least a portion of the first nozzle is located inside the second nozzle.

In some embodiments, the first nozzle and the second nozzle are coaxially positioned.

In some embodiments, the first nozzle and the second nozzle are not coaxially positioned.

In some embodiments, the first nozzle and the second nozzle have the same shape.

In some embodiments, the first nozzle has a round shape.

In some embodiments, the first nozzle has a nonround shape.

In some embodiments, the second nozzle has a round shape.

In some embodiments, the second nozzle has a nonround shape.

In some embodiments, a tip of the second nozzle is located below a tip of the first nozzle.

In some embodiments, a tip of the second nozzle is located above a tip of the first nozzle.

In some embodiments, the first nozzle is longer than the second nozzle.

In some embodiments, the second nozzle is longer than the first nozzle.

In some embodiments, the device further includes a flow deflector coupled with the first nozzle.

In some embodiments, the flow deflector causes a spiral flow of a dispensed wash liquid.

In some embodiments, the flow deflector causes a radial flow of a dispensed wash liquid.

In some embodiments, one or more cutouts are defined in an outer nozzle between the first nozzle and the second nozzle for dispensing a wash liquid in one or more directions non-parallel to an axis defined by a shaft of the dispensing nozzle.

In some embodiments, the direction of the dispensed wash liquid is perpendicular to an axis defined by a shaft of an outer nozzle between the first nozzle and the second nozzle.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An apparatus, comprising:
a dispenser with a dispenser nozzle for dispensing a wash liquid to a sample liquid; and
an aspirator with an aspirator nozzle, distinct from the dispenser nozzle, for aspirating a mixture of the wash liquid and the sample liquid,
wherein the dispenser nozzle is integrated with the aspirator nozzle.

2. The apparatus of claim 1, wherein:
the dispenser nozzle is in contact with the aspirator nozzle.

3. The apparatus of claim 1, wherein:
the dispenser nozzle is at least partially surrounded by the aspirator nozzle.

4. The apparatus of claim 1, wherein:
at least a portion of the dispenser nozzle is located inside the aspirator nozzle.

5. The apparatus of claim 1, wherein:
the aspirator nozzle is at least partially surrounded by the dispenser nozzle.

6. The apparatus of claim 1, wherein:
at least a portion of the aspirator nozzle is located inside the dispenser nozzle.

7. The apparatus of claim 1, wherein:
the dispenser nozzle and the aspirator nozzle are coaxially positioned.

8. The apparatus of claim 1, wherein:
the dispenser nozzle and the aspirator nozzle are not coaxially positioned.

9. The apparatus of claim 1, wherein:
the dispenser nozzle and the aspirator nozzle have the same shape.

10. The apparatus of claim 1, wherein:
the dispenser nozzle has a round shape.

11. The apparatus of claim 1, wherein:
the dispenser nozzle has a non-round shape.

12. The apparatus of claim 1, wherein:
the aspirator nozzle has a round shape.

13. The apparatus of claim 1, wherein:
the aspirator nozzle has a non-round shape.

14. The apparatus of claim 1, wherein:
a tip of the aspirator nozzle is located below a tip of the dispenser nozzle.

15. The apparatus of claim 1, wherein:
a tip of the aspirator nozzle is located above a tip of the dispenser nozzle.

16. The apparatus of claim 1, further comprising:
a flow deflector coupled with the dispenser nozzle.

17. The apparatus of claim 16, wherein:
the flow deflector causes a spiral flow of the dispensed wash liquid.

18. The apparatus of claim 16, wherein:
the flow deflector causes a radial flow of the dispensed wash liquid.

19. The apparatus of claim 1, wherein:
one or more cutouts are defined in the dispensing nozzle for dispensing the wash liquid in one or more directions non-parallel to an axis defined by a shaft of the dispensing nozzle.

20. The apparatus of claim 18, wherein:
the direction of the dispensed wash liquid is perpendicular to an axis defined by a shaft of the dispensing nozzle.
